(19) United States
(12) Patent Application Publication
(10) Pub. No.: US 2025/0268350 A1
(43) Pub. Date: Aug. 28, 2025

(54) PROTECTIVE CASE WITH BUTTON

(71) Applicant: Shenzhen DeOne Innovation Technology Co.,LTD., Shenzhen (CN)

(72) Inventor: Jianle Li, Quanzhou (CN)

(73) Assignee: Shenzhen DeOne Innovation Technology Co.,LTD., Shenzhen (CN)

(21) Appl. No.: 19/023,556

(22) Filed: Jan. 16, 2025

(30) Foreign Application Priority Data
Feb. 23, 2024 (CN) 2024203394470

(51) Int. Cl. A45C 11/00

(52) U.S. Cl. CPC A45C 11/002; A45C 11/003

(57) ABSTRACT

Disclosed is a protective case with a button, including a back plate closely fitting a back face of a mobile device, and a side plate closely fitting side surfaces of the mobile device, a control circuit board is arranged on the protective case, a pressing portion is arranged on the side plate, a first surface of the pressing portion is configured for the user to press, a second surface thereof is assembled with a button portion coupled with the control circuit board, and the assembled button portion is flush with an inner side surface of the side plate or is recessed relative to the inner side surface of the side plate; and a signal transceiver is coupled to the control circuit board, the signal transceiver is in signal connection with the mobile device, and the control circuit board controls the mobile device through the signal transceiver.

### TECHNICAL FIELD

The present disclosure relates to the technical field of protective cases, and in particular to a protective case with a button.

### BACKGROUND

Nowadays, mobile devices have become essential in people's daily lives, offering great convenience for people. Many Apps installed in the mobile devices enable a wide range of functions and enhance versatility of the mobile devices. After purchasing mobile devices, many users will provide the mobile devices with protective cases. However, existing protective cases for the mobile devices are usually attached to backs of the mobile devices to prevent scratches caused by collisions with other objects and to mitigate an impact on the mobile devices when they fall down, thereby providing protection for the mobile devices.

A mobile device case in the prior art is provided with a button capable of interacting with a mobile device. However, the button is usually arranged on a back face of the mobile device case, which looks somewhat awkward and easily affects an overall appearance of the mobile device case. When the button is arranged on a side surface of the mobile device case, a part of the button located on an inner side surface thereof tends to press against the mobile device, making the mobile device difficult to be removed from the mobile device case in a minor case or causing the mobile device to deform in a severe case.

### SUMMARY

In view of the defects and shortcomings of the prior art, an objective of the present disclosure is to provide a protective case with a button, which is arranged on a side surface of the protective case and does not exert pressure on a mobile device.

To achieve the above objective, the present disclosure adopts the following technical solution: a protective case with a button, including a back plate closely fitting a mobile device, and a side plate closely fitting the mobile device, where a control circuit board is arranged on the back plate, a pressing portion is arranged on the protective case, a first surface of the pressing portion is arranged for the user to press, a second surface thereof is assembled with a button portion coupled with the control circuit board, and the assembled button portion is flush with an inner side surface of the side plate or is recessed relative to the inner side surface of the side plate; and a signal transceiver is coupled to the control circuit board, the signal transceiver is in signal connection with the mobile device, and when the button portion is triggered, the control circuit board controls the mobile device through the signal transceiver.

Preferably, a through hole is formed in the side plate, the pressing portion is fixedly arranged in the through hole, and the first surface of the pressing portion is arranged to protrude relative to an outer side surface of the side plate.

Preferably, an extension piece is arranged on the control circuit board, and the extension piece is coupled with the button portion such that the button portion is coupled with the control circuit board.

Preferably, guide grooves for assembling the extension piece are formed on the side plate and the back plate, and the assembled extension piece is flush with an inner side surface of the side plate or is recessed relative to the inner side surface of the side plate.

Preferably, the control circuit board is arranged in the back plate, a through slot is formed in a side of the back plate close to the guide groove, and the through slot allows the extension piece to extend out from the back plate.

Preferably, the second surface of the pressing portion and the through hole together form a fitting groove, and the fitting groove is configured to accommodate the button portion.

Preferably, the pressing portion is a button, the button is made of an elastic material, and the button portion is a tactile switch or a touch switch.

Preferably, a bump is arranged on the first surface of the pressing portion, and the bump is arranged to correspond to a trigger structure of the button portion.

Preferably, an anti-slip structure is arranged on the second surface of the pressing portion.

Preferably, the extension piece, the button portion and the control circuit board are integrally formed, and all of them are FPC boards.

Based on the above technical scheme, the present disclosure has the following beneficial effects: the protective case includes the back plate closely fitting a back face of the mobile device, and the side plate closely fitting side surfaces of the mobile device, the pressing portion is arranged on the side plate, the button portion is arranged on the control circuit board, and when the pressing portion is pressed by the user, the button portion will be triggered, such that the signal transceiver coupled on the control circuit board transmits a signal to the mobile device, and the assembled button portion is flush with the inner side surface of the side plate or is recessed relative to the inner side surface of the side plate. Therefore, the present disclosure is capable of effectively preventing the mobile device from being squeezed so as to better protect the mobile device.

### BRIEF DESCRIPTION OF THE DRAWINGS

In order to more clearly describe the technical solutions in the examples of the present disclosure or in the prior art, a brief introduction to the accompanying drawings required for the description of the examples or the prior art will be made below. Apparently, the accompanying drawings in the following description are merely some examples of the present disclosure, and those of ordinary skill in the art would also be able to derive other drawings from these drawings without making creative efforts.

FIG. 1 is a structural schematic diagram of the present disclosure.

FIG. 2 is an exploded view corresponding to FIG. 1.

FIG. 3 is a structural schematic diagram of a control circuit board of the present disclosure.

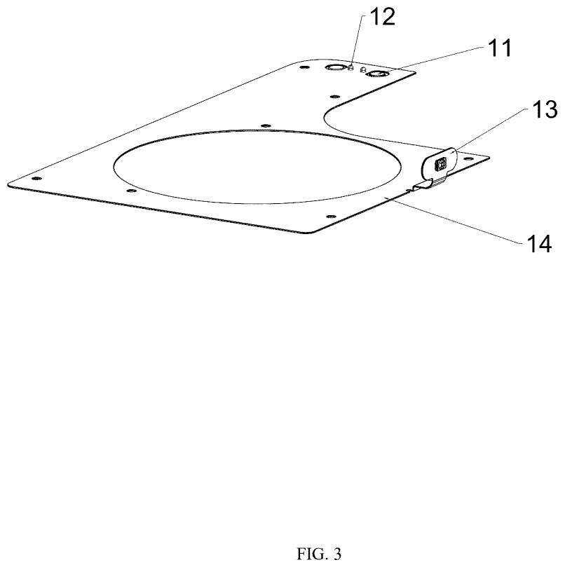

FIG. 4 is a schematic diagram of a partial structure of the present disclosure.

FIG. 5 is schematic diagram of another view corresponding to FIG. 4.

Description of reference numerals: 1. back plate; 11. magnet; 12. charging contact; 13. button portion; 14. control circuit board; 15. base plate; 151. power slot; 152. magnetic attraction area; 153. placement part; 154. snap-fit edge; 155. through slot; 156. positioning part; 16. annular magnet; 17. power supply; 18. cover plate; 181. charging hole; 2. side plate; 21. button sleeve; 22. visual window; 23. snap-fit groove; 24. pressing portion; 241. guide groove; 242. fitting groove; 243. button; 244. bump; 245. anti-slip structure; and 246. through hole.

### DETAILED DESCRIPTIONS OF THE EMBODIMENTS

The present disclosure is further described in detail below with reference to the accompanying drawings.

This specific example is merely an explanation of the present disclosure and is not intended to limit the present disclosure. After reading the specification, those skilled in the art may make non-creative modifications to the present example as needed, but such modifications are protected by the patent law as long as they fall within the scope of the claims of the present disclosure.

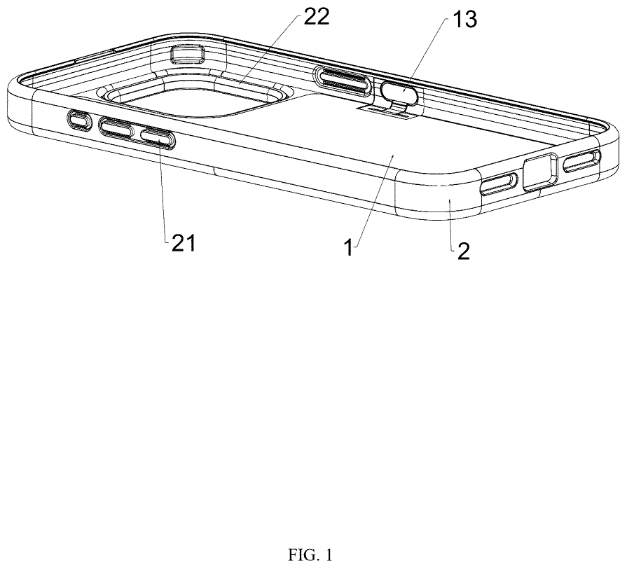

This example relates to a protective case with a button. As illustrated in FIG. 1, the protective case is specifically a mobile device case, which can wrap around a back face and side surfaces of a mobile device to prevent scratches caused by collisions with other objects and to mitigate an impact on the mobile devices when the mobile device falls down, thereby providing protection for the mobile device. A button sleeve 21 corresponding to the mobile device button is arranged on a side surface of the protective case to protect the mobile device button. In other examples, the protective case can also be a protective case for a tablet PC, or a handheld game console or any other electronic device.

Preferably, the protective case is provided with a back plate 1 and a side plate 2, where the back plate 1 is arranged for closely fitting a back face of a mobile device, and the side plate 2 is arranged for closely fitting side surfaces of the mobile device to protect the side surfaces and the back face of the mobile device. A power supply 17 is arranged on the back plate 1, and the power supply 17 is configured to supply power to electronic elements inside the entire protective case. A specific charging method is as follows: a power connection part is arranged on a surface of the back plate 1 away from the mobile device, and the power connection part is coupled with an external charging device to charge the power supply 17. The power supply 17 is preferably a rechargeable lithium battery. It should be noted that the back plate 1 and the side plate 2 can be integrally formed, or be two fixedly assembled components.

In this example, the external charging device is a charging cable, and the power connection part is a charging contact 12, such that the external charging device is capable of charging the power supply 17 through the charging contact 12; and in other examples, a wireless charging coil can be arranged for wireless charging of the power supply 17.

In other examples, the power connection part is a charging cable, which is arranged at a bottom of the protective case and arranged for plug-in connection with an interface at a bottom of the mobile device to charge the mobile device, or to charge the power supply 17 through the mobile device.

Preferably, a magnet 11 is arranged on a side close to the charging contact 12, and the magnet 11 is arranged for magnetic attraction alignment between the charging contact 12 and the external charging device to prevent misalignment of the charging contact.

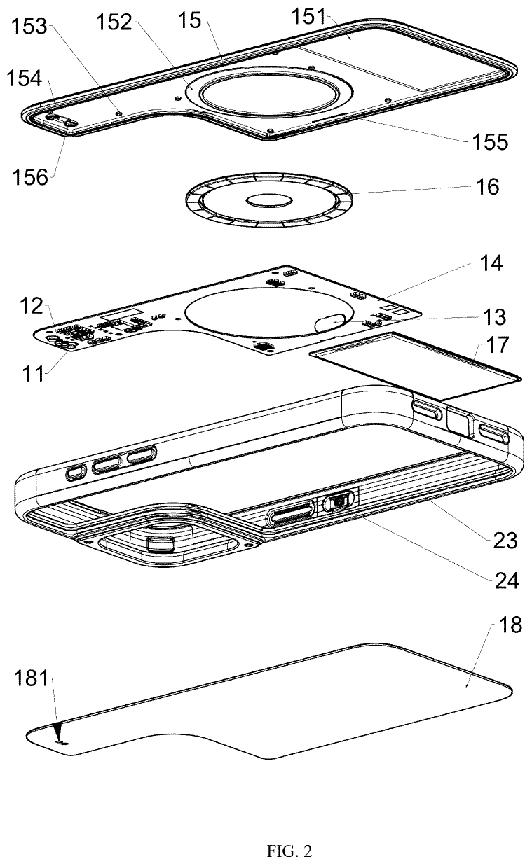

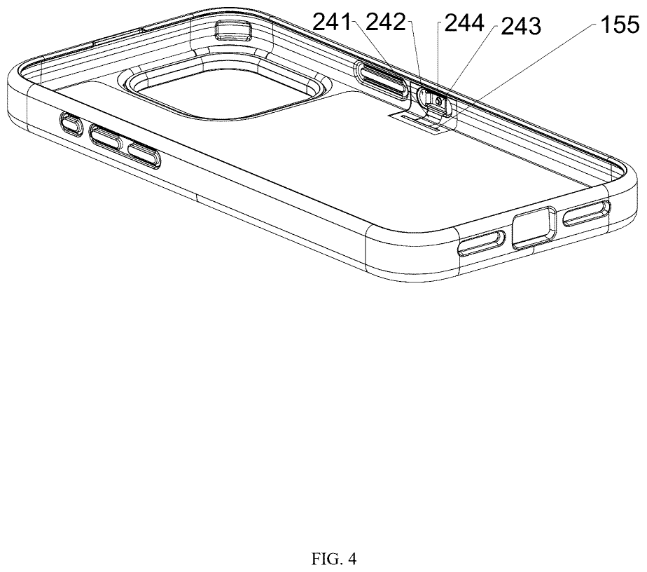

As illustrated in FIGS. 2 and 4, a control circuit board 14 is further arranged in the protective case. Specifically, the control circuit board 14 in this solution is arranged in the back plate 1, a signal transceiver is coupled to the control circuit board 14, and the signal transceiver is in signal connection with the mobile device. A button portion 13 coupled with the control circuit board 14 is further arranged on the side plate 2, and when the user presses the button portion 13, the control circuit board 14, controls the mobile device through the signal transceiver to perform operations such as answering or hanging up calls, activating or inactivating recording, enabling camera shooting, or opening APPs, so as to enhance interactivity between the protective case and the mobile device. In this example, the signal transceiver is preferably Bluetooth.

In other examples, the signal transceiver is also capable of receiving command signals transmitted to the mobile device to control the protective case, for example, a signal cut-off command is sent to interrupt the signal connection between the signal transceiver and the mobile device. The signal transceiver can be WIFI.

In other examples, the button portion 13 is not arranged, but a voice recognition module is arranged on the back plate 1 or the side plate 2, where the voice recognition module is configured to recognize and filter voice information from the user, then generates a voice command, and sends the voice command to the control circuit board 14, and the control circuit board 14 sends the voice command to the mobile device through the signal transceiver to realize voice control of the mobile device.

In another example, the button portion 13 can also be arranged on the back plate 1, and a pressing portion 24 is also correspondingly arranged on the back plate 1. A plurality of the button portions 13 can be arranged, for example, at least one of the button portions 13 can be arranged on the side plate 2 and the back plate 1 respectively, and the different button portions 13 can correspondingly control different functions of the mobile device. In another solution, the control circuit board 14 can also be arranged inside the side plate 2.

Preferably, the pressing portion 24 is arranged on the side plate 2, a first surface of the pressing portion 24 is arranged for the user to press, and a second surface thereof is assembled with the button portion 13, such that when the pressing portion 24 is pressed, a trigger structure of the button portion 13 can be triggered; and the assembled button portion 13 is flush with an inner side surface of the side plate 2 or is recessed relative to the inner side surface of the side plate 2, thereby effectively preventing the mobile device from being squeezed when it is placed in the protective case. The pressing portion 24 is capable of protecting the button portion 13.

It should be noted that a through hole 246 is formed in the side plate 2, the through hole 246 is communicated with inner and outer surfaces of the side plate 2, and the pressing portion 24 is fixedly arranged in the through hole 246, such that the through hole 246 can be completely or partially covered. The first surface of the pressing portion 24 is arranged to protrude relative to an outer side surface of the side plate 2, the second surface thereof is arranged to be recessed relative to the inner side surface of the side plate 2, the second surface thereof and the through hole 246 together form a fitting groove 242, and the fitting groove 242 is configured to facilitate the mounting of the button portion 13, such that the button portion 13 is flush with the inner side surface of the side plate 2 or is recessed relative to the inner side surface of the side plate 2.

Preferably, an extension piece is coupled to the control circuit board 14, and the extension piece is coupled with the button portion 13 such that the button portion 13 can be coupled with the control circuit board 14. The extension piece is arranged to be bent, and a bending curvature at both ends of the extension piece is adapted to the side plate 2 and the back plate 1, such that the extension piece fits an inner side of the side plate 2 of the protective case.

It should be noted that guide grooves 241 for assembling the extension piece are formed on the side plate 2 and the back plate 1, a depth of the guide grooves 241 matches a thickness of the extension piece, and the assembled extension piece is flush with an inner side surface of the side plate 2 or is recessed relative to the inner side surface of the side plate 2, thereby preventing the extension piece from being squeezed when the mobile device is placed in the protective case.

Preferably, the control circuit board 14 is arranged in an interlayer inside the back plate 1, a through slot 155 is formed in a side of the back plate 1 close to the guide groove 241, and the through slot 155 allows the extension piece to extend out from the back plate 1, such that the extension piece is coupled with the button portion 13.

In other examples, the control circuit board 14 is not arranged inside the back plate 1, but is fixedly arranged on a surface of the back plate 1 close to the mobile device, in which case, the through slot 155 in the back plate 1 is not needed, and the extension piece can be directly coupled with the button portion 13.

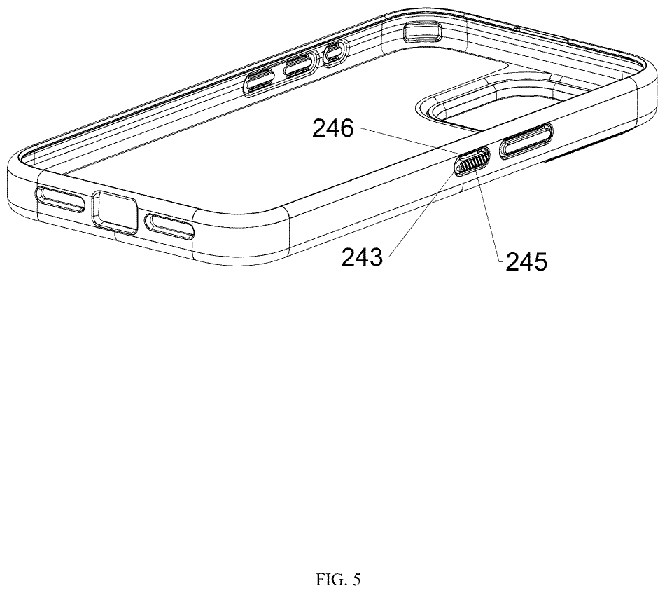

As illustrated in FIG. 5, the button portion 13 is a tactile switch or a touch switch, the pressing portion 24 is a button 243, and the button 243 is made of an elastic material and is capable of rebounding after being pressed by the user. In this example, the button 243 is made of a TPU material. In other examples, the button 243 is a spring button.

Preferably, a bump 244 is arranged on the first surface of the pressing portion 24, and the bump 244 is arranged to correspond to the trigger structure of the button portion 13, such that when the pressing portion 24 is pressed, the button portion 13 can be triggered by means of the bump 244. An anti-slip structure 245 is arranged on the second surface of the pressing portion 24, and the anti-slip structure 245 is capable of increasing a friction force when the user presses to prevent slipping.

Preferably, the extension piece, the button portion 13 and the control circuit board 14 are integrally formed, and all of them are FPC boards. In other examples, the extension piece is a wire, the button portion 13 is a circuit board, and the circuit board is electrically connected to the control circuit board 14 through the wire.

As illustrated in FIG. 2, the back plate 1 is formed by pressing a plurality of sheets together, including a base plate 15 and a cover plate 18, where the base plate 15 is arranged on a surface close to the mobile device, and the cover plate 18 is arranged on a surface away from the mobile device. A surface of the base plate 15 away from the mobile device is provided with a power slot 151, a magnetic attraction area 152, and placement parts 153 respectively, where the power slot 151 is arranged for placing the power supply 17, and the magnetic attraction area 152 is arranged for wirelessly charging the mobile device through an external magnetic wireless charger. The magnetic attraction area 152 in this example is an annular groove body, and an annular magnet 16 is arranged in the groove body to improve an adsorption capacity of the external magnetic wireless charger. The placement parts 153 are arranged for placing the control circuit board 14. Specifically, the placement parts 153 are protruding positioning columns, positioning holes for the positioning columns to penetrate through are formed in the control circuit board 14, and a plurality of the positioning columns and the positioning holes are arranged.

Preferably, a positioning part 156 is further arranged on the base plate 15, the positioning part 156 is arranged for facilitating mounting of the charging contact 12 and the magnet 11 on the base plate 15, and specifically, the positioning part 156 is a positioning groove, and the positioning groove matches the charging contact 12 and the magnet 11 in shape. A charging hole 181 is formed in the cover plate 18, and the charging hole 181 is configured for exposing the charging contact 12, such that the external charging device is coupled with the charging contact 12.

It should be noted that the cover plate 18 is arranged on the base plate 15 to cover the power slot 151, the magnetic attraction area 152 and the placement parts 153, so as to protect the electronic elements placed therein. The through slot 155 is formed on the side of the base plate 15, and the through slot 155 allows the extension piece to extend to the side plate 2 through the base plate 15.

Preferably, a snap-fit edge 154 is arranged on an edge of the back plate 1, and a snap-fit groove 23 corresponding to the snap-fit edge 154 is formed on the side plate 2, and the back plate 1 and the side plate 2 are fixedly assembled with the snap-fit groove 23 through the snap-fit edge 154.

In this example, a visual window 22 for exposing cameras of the mobile device is arranged on the side plate 2, an avoidance area that fits an outer edge of the visual window 22 is arranged on the back plate 1, and the avoidance area is configured for the back plate 1 to fit with the side plate 2 with the visual window 22. The visual window 22 in other examples can be arranged on the back plate 1, and in this case, the avoidance area is not arranged on the back plate 1. The power connection part is arranged on a side close to the avoidance area.

The above examples are merely intended for describing the technical solution of the present disclosure rather than limiting same. Any other modifications or equivalent substitutions made to the technical solution of the present disclosure by those skilled in the art, without departing from the spirit and scope of the technical solution of the present disclosure, all fall within the scope of the claims of the present disclosure.

What is claimed is:

1. A protective case with a button, comprising a back plate closely fitting a back face of a mobile device, and a side plate closely fitting side surfaces of the mobile device, wherein a control circuit board is arranged on the protective case, a pressing portion is arranged on the side plate, a first surface of the pressing portion is configured for the user to press, a second surface thereof is assembled with a button portion coupled with the control circuit board, and the assembled button portion is flush with an inner side surface of the side plate or is recessed relative to the inner side surface of the side plate; and
a signal transceiver is coupled to the control circuit board, and the signal transceiver is in signal connection with the mobile device; and when the button portion is triggered, the control circuit board controls the mobile device through the signal transceiver.

2. The protective case with a button according to claim 1, wherein a through hole is formed in the side plate, the pressing portion is fixedly arranged in the through hole, and the first surface of the pressing portion is arranged to protrude relative to an outer side surface of the side plate.

3. The protective case with a button according to claim 1, wherein an extension piece is arranged on the control circuit board, and the extension piece is coupled with the button portion, such that the button portion is coupled with the control circuit board.

4. The protective case with a button according to claim 3, wherein guide grooves for assembling the extension piece are formed on the side plate and the back plate, and the assembled extension piece is flush with an inner side surface of the side plate or is recessed relative to the inner side surface of the side plate.

5. The protective case with a button according to claim 4, wherein the control circuit board is arranged in the back plate, a through slot is formed in a side of the back plate close to the guide groove, and the through slot allows the extension piece to extend out from the back plate.

6. The protective case with a button according to claim 2, wherein the second surface of the pressing portion and the through hole together form a fitting groove, and the fitting groove is configured for accommodating the button portion.

7. The protective case with a button according to claim 6, wherein the pressing portion is a button, the button is made of an elastic material, and the button portion is a tactile switch or a touch switch.

8. The protective case with a button according to claim 6, wherein a bump is arranged on the first surface of the pressing portion, and the bump is arranged to correspond to a trigger structure of the button portion.

9. The protective case with a button according to claim 6, wherein an anti-slip structure is arranged on the second surface of the pressing portion.

10. The protective case with a button according to claim 3, wherein the extension piece, the button portion and the control circuit board are integrally formed, and all of them are FPC boards.
